(19) United States
(12) Patent Application Publication
(10) Pub. No.: US 2014/0316881 A1
(43) Pub. Date: Oct. 23, 2014

(54) ESTIMATION OF AFFECTIVE VALENCE AND AROUSAL WITH AUTOMATIC FACIAL EXPRESSION MEASUREMENT

(71) Applicant: Emotient, San Diego, CA (US)

(72) Inventors: Javier MOVELLAN, La Jolla, CA (US); Marian Steward BARTLETT, San Diego, CA (US); Ian FASEL, San Diego, CA (US); Gwen Ford LITTLEWORT, Solana Beach, CA (US); Joshua SUSSKIND, La Jolla, CA (US); Jacob WHITEHILL, Cambridge, MA (US)

(73) Assignee: EMOTIENT, San Diego, CA (US)

(21) Appl. No.: 14/180,352

(22) Filed: Feb. 13, 2014

Related U.S. Application Data
(60) Provisional application No. 61/764,442, filed on Feb. 13, 2013.

(51) Int. Cl. G06K 9/00; G06Q 30/02; G06K 9/62

(52) U.S. Cl. CPC G06K 9/00315; G06K 9/6227; G06Q 30/0243
USPC 705/14.42; 382/118

(57) ABSTRACT

Apparatus, methods, and articles of manufacture facilitate analysis of a person's affective valence and arousal. A machine learning classifier is trained using training data created by (1) exposing individuals to eliciting stimuli, (2) recording extended facial expression appearances of the individuals when the individuals are exposed to the eliciting stimuli, and (3) obtaining ground truth of valence and arousal evoked from the individuals by the eliciting stimuli. The classifier is thus trained to analyze images with extended facial expressions (such as facial expressions, head poses, and/or gestures) evoked by various stimuli or spontaneously obtained, to estimate the valence and arousal of the persons in the images. The classifier may be deployed in sales kiosks, online trough mobile and other devices, and in other settings.

### CROSS-REFERENCE TO RELATED APPLICATION

This application claims priority from U.S. provisional patent application Ser. No. 61/764,442, entitled ESTIMATION OF AFFECTIVE VALENCE AND AROUSAL WITH AUTOMATIC FACIAL EXPRESSION MEASUREMENT, filed on Feb. 13, 2013, Atty Dkt Ref MPT-1016-PV, which is hereby incorporated by reference in its entirety as if fully set forth herein, including text, figures, claims, tables, and computer program listing appendices (if present), and all other matter in the United States provisional patent application.

### FIELD OF THE INVENTION

This document relates generally to apparatus, methods, and articles of manufacture for estimation of a person's affective valence and arousal with automatic facial expression assessment systems that employ machine learning techniques.

### BACKGROUND

In modern societies, it is advantageous to be able to estimate individual and group reactions to various products, presentations, arguments, and other stimuli. Consequently, a need in the art exists to recognize such reactions automatically. A need in the art also exists to take actions based on individual and group reactions to the various stimuli, including real time actions responsive to the stimuli. This document describes methods, apparatus, and articles of manufacture that may satisfy any of these and possibly other needs.

### SUMMARY

Embodiments described in this document employ automatic facial expression assessment by machine learning systems to estimate affective valence and/or arousal of people and/or groups of people.

In an embodiment, a computer-implemented method includes steps of training machine learning facial expression classifiers with training data created by exposing individuals to eliciting stimuli, recording facial appearances of the individuals when the individuals are exposed to the eliciting stimuli, and determining estimates of valence and arousal evoked from the individuals by the eliciting stimuli, thereby obtaining facial expression classifiers configured to estimate valence and arousal; a server sending a first stimulus to be presented to a user of a user device, the user device including a camera and a network interface, the user device coupled to the server through a network; obtaining by the server facial expression data of the user during presentation of the first stimulus to the user; analyzing the facial expression data with the facial expression classifiers configured to estimate valence and arousal, thereby obtaining estimates of valence and arousal evoked by the first stimulus; selecting a second stimulus based on the estimates of valence and arousal evoked by the first stimulus; and the sever sending a second stimulus to be presented to the user of the user device.

In an embodiment, a computer-implemented method includes obtaining an image containing an extended facial expression of a person responding to a first stimulus. The method also includes processing the image containing the extended facial expression of the person with a machine learning classifier to obtain an estimate of valence and arousal of the person responding to the first stimulus. The classifier is trained using training data created by (1) exposing individuals to eliciting stimuli, (2) recording extended facial expression appearances of the individuals when the individuals are exposed to the eliciting stimuli, and (3) obtaining ground truth of valence and arousal evoked from the individuals by the eliciting stimuli.

In an embodiment, a computer-implemented method includes training a machine learning classifier using training data. The training data is created by (1) exposing individuals to eliciting stimuli, (2) recording extended facial expression appearances of the individuals when the individuals are exposed to the eliciting stimuli, and (3) obtaining ground truth of valence and arousal evoked from the individuals by the eliciting stimuli. A machine learning classifier trained to estimate valence and arousal is thus obtained.

In an embodiment, a computing device includes at least one processor. The computing device also includes machine-readable storage coupled to the at least one processor. The machine-readable storage stores instructions executable by the at least one processor. The computing device also includes means for allowing the at least one processor to obtain images comprising extended facial expressions of a person responding to stimuli, for example, a camera of the computing device, or a network interface coupling the computing device to a user device through a network. When the instructions are executed by the at least one processor, they configure the at least one processor to implement a machine learning classifier trained to estimate valence and arousal. The classifier is trained with training data created by (1) exposing individuals to eliciting stimuli, (2) recording extended facial expression appearances of the individuals when the individuals are exposed to the eliciting stimuli, and (3) obtaining ground truth of valence and arousal evoked from the individuals by the eliciting stimuli. Additionally, when the instructions are executed by the at least one processor, they further configure the at least one processor to analyze a first image comprising an extended facial expression of the person responding to a first stimulus, using the classifier, to obtain an estimate of valence and arousal of the first person responding to the first stimulus.

These and other features and aspects of the present invention will be better understood with reference to the following description, drawings, and appended claims.

### BRIEF DESCRIPTION OF THE FIGURES

FIG. 1 is a simplified block diagram representation of a computer-based system configured in accordance with selected aspects of the present description; and

FIG. 2 illustrates selected steps of a process for selecting and presenting advertisement based on valence and arousal evoked in a user by a previous advertisement.

### DETAILED DESCRIPTION

In this document, the words “embodiment,” “variant,” “example,” and similar expressions refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place or context may refer to a different apparatus, process, or article of manufacture. The expression “alternative embodiment” and similar expressions and phrases may be used to indicate one of a number of different possible embodiments. The number of possible embodiments/variants/examples is not necessarily limited to two or any other quantity. Characterization of an item as “exemplary” means that the item is used as an example. Such characterization of an embodiment/variant/example does not necessarily mean that the embodiment/variant/example is a preferred one; the embodiment/variant/example may but need not be a currently preferred one. All embodiments/variants/examples are described for illustration purposes and are not necessarily strictly limiting.

The words “couple,” “connect,” and similar expressions with their inflectional morphemes do not necessarily import an immediate or direct connection, but include within their meaning connections through mediate elements.

“Affective valence,” as used in this document, means the degree of positivity or negativity of emotion. Joy and happiness, for example, are positive emotions; anger, fear, sadness, and disgust are negative emotions; and surprise is an emotion close to a neutral. “Arousal” is the degree to which a particular emotion is experienced. Thus, here we use a two-dimensional approach to emotion characterization, that is, on the scales of (1) affective valence, which is the positive/negative quality of the emotion, and (2) arousal, which is the strength of the emotion.

“Facial expression” as used in this document signifies the facial expressions of primary emotion (such as Anger, Contempt, Disgust, Fear, Happiness, Sadness, Surprise, Neutral); expressions of affective state of interest (such as boredom, interest, engagement); so-called “action units” (movements of a subset of facial muscles, including movement of individual muscles); changes in low level features (e.g., Gabor wavelets, integral image features, Haar wavelets, local binary patterns (LBP), Scale-Invariant Feature Transform (SIFT) features, histograms of gradients (HOG), Histograms of flow fields (HOFF), and spatio-temporal texture features such as spatiotemporal Gabors, and spatiotemporal variants of LBP such as LBP-TOP); and other concepts commonly understood as falling within the lay understanding of the term.

“Extended facial expression” means “facial expression” (as defined above), head pose, and/or gesture. Thus, “extended facial expression” may include only “facial expression”; only head pose; only gesture; or any combination of these expressive concepts.

“Stimulus” and its plural form “stimuli” refer to actions, agents, or conditions that elicit or accelerate a physiological or psychological activity or response, such as an emotional response. Specifically, stimuli include exposure to products, presentations, arguments, still pictures, video clips, smells, tastes, sounds, and other sensory and psychological stimuli; such stimuli may be referred to as “eliciting stimuli” in the plural form, and “eliciting stimulus” in the singular form.

The word “image” refers to still images, videos, and both still images and videos. A “picture” is a still image. “Video” refers to motion graphics.

“Causing to be displayed” and analogous expressions refer to taking one or more actions that result in displaying. A computer or a mobile device (such as a smart phone, tablet, Google Glass and other wearable devices), under control of program code, may cause to be displayed a picture and/or text, for example, to the user of the computer. Additionally, a server computer under control of program code may cause a web page or other information to be displayed by making the web page or other information available for access by a client computer or mobile device, over a network, such as the Internet, which web page the client computer or mobile device may then display to a user of the computer or the mobile device.

“Causing to be rendered” and analogous expressions refer to taking one or more actions that result in displaying and/or creating and emitting sounds. These expressions include within their meaning the expression “causing to be displayed,” as defined above. Additionally, the expressions include within their meaning causing emission of sound.

Other and further explicit and implicit definitions and clarifications of definitions may be found throughout this document.

Reference will be made in detail to several embodiments that are illustrated in the accompanying drawings. Same reference numerals may be used in the drawings and the description to refer to the same apparatus elements and method steps. The drawings are in a simplified form, not to scale, and omit apparatus elements, method steps, and other features that can be added to the described systems and methods, while possibly including certain optional elements and steps.

In selected embodiments described throughout this document, machine learning is employed to develop classifiers of a person's affective valence and/or arousal, based on extended facial expression of the person. Spontaneous facial and extended facial responses to products, presentations, arguments, and other stimuli may be evaluated using the valence and/or arousal classifiers, making simple measures of the person's positive/negative affective dimension and the magnitude of the evoked emotion of the person available for evaluations of the stimuli.

To obtain data used in such machine learning training, various stimuli that are designed to elicit a range of affective responses, from positive to negative, may be presented to individual subjects, and the subjects' extended facial expression responses recorded together with objective and subjective estimates of the individuals' responses to the stimuli. Such stimuli may include pictures of spiders, snakes, comics, and cartoons; and pictures from the International Affective Picture set (IAPS). IAPS is described in Lang et al., The International Affective Picture System (University of Florida, Centre for Research in Psychophysiology, 1988), which publication is hereby incorporated by reference in its entirety. The emotion eliciting stimuli may also include film clips, such as clips of spiders/snakes/comedies, and the normed set from Gross & Levenson, Emotion Elicitation Using Films, Cognition and Emotion, 9, 87-108 (1995), which publication is hereby incorporated by reference in its entirety. The stimuli may be obtained from publicly available sources, such as Youtube, and may additionally include fragrances, flavors, music and other sounds. Stimuli may also include a startle probe, which may be given in conjunction with emotion eliciting paradigms, or separately. (Examples of emotion-eliciting paradigms and startle probes are described in U.S. patent application Ser. No. 14/179,481, entitled FACIAL EXPRESSION MEASUREMENT FOR ASSESSMENT, MONITORING, AND TREATMENT EVALUATION OF AFFECTIVE AND NEUROLOGICAL DISORDERS, filed on Feb. 12, 2014, Atty Dkt Ref MPT-1014-UT, which is hereby incorporated by reference in its entirety as if fully set forth herein, including text, figures, claims, tables, and computer program listing appendices, if present, and all other matter in the patent application.) Stimuli may further include neutral (baseline) stimuli.

The extended facial expression responses of the subjects to the stimuli may be recorded, for example, video recorded. Alternatively, the extended facial expressions may be obtained without purposefully presenting stimuli to the subjects; for example, the images with the extended facial expressions may be taken when the subjects are engaged in spontaneous activity. The expressions, however obtained, may be measured by automated facial expression measurement (“AFEM”) techniques, which provide relatively accurate and discriminative quantification of emotions and affective states. The collection of the measurements may be considered to be a vector of facial responses. The vector may include a set of displacements of feature points, motion flow fields, facial action intensities from the Facial Action Coding System (“FACS”), and/or responses of a set of automatic expression detectors or classifiers trained to detect and classify the seven basic emotions and possibly other emotions and/or affective states. The vector may also include measurements obtained using the Computer Expression Recognition Toolbox (“CERT”) and/or FACET technology for automated expression recognition. CERT was developed at the machine perception laboratory of the University of California, San Diego; FACET was developed by Emotient, the assignee of this application.

Probability distributions for one or more extended facial expression responses for the subject population may be calculated, and the parameters (e.g., mean, variance, and/or skew) of the distributions computed.

The training data thus obtained (the recordings of extended facial expressions and the ground truth from AFEM and/or the basic emotion classifiers correlated with such recordings) may be used to create and refine one or more classifiers of affective valence and/or arousal. For example, faces in the recordings are first detected and aligned. Image features may then be extracted. Motion features may be extracted using optic flow and/or feature point tracking, and/or active appearance models. Feature selection and clustering may be performed on the image features. Facial actions from the Facial Action Coding System (FACS) may be automatically detected from the image features. Machine learning techniques and statistical models may be employed to characterize the relationships between (1) extended facial expression responses from the basic emotion classifiers and/or AFEM, and (2) various ground truth measures, which may include either or both objective and subjective measures of valence and arousal. Subjective measures, for example, may include self-ratings scales for dimensions such as affective valence, arousal, and basic emotions; and third-party evaluations. Objective ground truth may be collected from sources including heart rate, heart rate variability, skin conductance, breathing rate, pupil dilation, blushing, imaging data from MRI and/or functional MRI of the entire brain or portions of the brain such as amygdala.

The nature of the eliciting stimuli may also be used as an objective measure of the valence/arousal. For example, expressions responsive to stimuli known to elicit fear may be labeled as negative valence and high arousal expressions, because such labels are expected to be statistically correlated with the true valance and arousal.

So-called “direct training” is another approach to machine learning of valence and arousal. The direct training approach works as follows. Videos of the subjects' extended facial expression responses to a range of valence/arousal stimuli are collected, as described above. Ground truth is also collected, as described above. Here, however, instead of or in addition to extracting extended facial expression measurements and applying machine learning to them, machine learning may be applied directly to the low-level image descriptors. The low level image descriptors may include but are not limited to Gabor wavelets, integral image features, Haar wavelets, local binary patterns (“LBP”), Scale-Invariant Feature Transform (“SIFT”) features, histograms of gradients (“HOG”), Histograms of flow fields (“HOFF”), and spatio-temporal texture features such as spatiotemporal Gabors, and spatiotemporal variants of LBP such as LBP-TOP. These image features are then passed to classifiers trained with machine learning techniques to discriminate positive valence from negative valence responses, and/or to differentiate low levels of arousal from high levels of arousal.

The machine learning techniques used here include support vector machines (“SVMs”), boosted classifiers such as Adaboost and Gentleboost, “deep learning” algorithms, action classification approaches from the computer vision literature, such as Bags of Words models, and other machine learning techniques, whether mentioned anywhere in this document or not.

The Bags of Words model is described in Sikka et al., Exploring Bag of Words Architectures in the Facial Expression Domain (UCSD 2012) (available at http://mplab.ucsd.edu/˜marni/pubs/Sikka_LNCS_{—}2012.pdf). Bags of Words is a computer vision approach known in the text recognition literature, which involves clustering the training data, and then histogramming the occurrences of the clusters for a given example. The histograms are then passed to standard classifiers such as SVM.

After the training, the classifier may provide information about new, unlabeled data, such as the estimates of affective valence and arousal of new images.

The analysis of extended facial expression behavior for estimating positive/negative valence/arousal is not necessarily limited to assessment of static variables. The dynamics of the subjects' facial behavior as it relates to valence may also be characterized and modeled; and the same may be done for high and low arousal. Parameters may include onset latencies, peaks of deviations in facial measurement of predetermined facial points or facial parameters, durations of movements of predetermined facial points or facial parameters, accelerations (rates of change in the movements of predetermined facial points or facial parameters), overall correlations (e.g., correlations in the movements of predetermined facial points or facial parameters), and the differences between the areas under the curve plotting the movements of predetermined facial points or facial parameters. The full distributions of response trajectories may be characterized through dynamical models such as the hidden Markov Models (“HMMs”), Kalman filters, diffusion networks, and/or others. The dynamical models may be trained directly on the sequences of low-level image features, on sequences of intermediate level features, AFEM outputs, and/or on sequences of large scale features such as the outputs of classifiers of primary emotions. Separate models may be trained for positive valence and negative valence. After training, the models may provide a measure of the likelihood that the facial data was of positive or negative valence. The ratio of the two likelihoods (likelihood of positive valence to likelihood of negative valence) may provide a value for class decision. (For example, values of >1 may indicate positive valence, and values <1 may indicate negative valence). This approach may be repeated to obtain estimates of arousal.

The classifiers may be trained to predict positive versus negative arousal; and/or positive valence versus neutral valence; and/or negative valence versus neutral valence.

Once these relationships are learned from the extended facial expressions of the subjects, the models (that is, the classifiers using the models) can estimate valence and arousal responses of new images (videos/pictures of extended facial expressions) for which ground truth is not available. Machine learning methods may include (but are not limited to) regression, multinomial logistic regression, support vector machines, support vector regression, relevance vector machines, Adaboost, Gentleboost, and other machine learning techniques, whether mentioned anywhere in this document or not. The multiple ground-truth measures may be combined using multiple-input and multiple-output predictive models, including latent regression techniques, generalized estimating equation (“GEE”) regression models, multiple-output regression, and multiple-output SVMs.

A classifier, trained as described above to recognize affective valence and arousal may be employed in the field to evaluate responses of new subjects (for whom ground truth may be unavailable) to various stimuli. For example, valence and arousal classifiers may be coupled to receive video recording of focus group participants discussing and/or sampling various products, ideas, positions, and similar evocative items/concepts. The outputs of the valence and arousal classifiers may be recorded and/or displayed, and used for selection of products, marketing strategies, and political positions and talking points. In a similar way, the valence/arousal classifiers may be used on individual marketing research participants, and for evaluating responses of visitors of marketing kiosks in shopping centers, trade shows, and stores.

The valence/arousal classifiers may also be used to evaluate responses to information presented to a person online, such as web-based advertising. For example, a computing device (of whatever nature) may cause an advertisement to be displayed to a user of a computer or a mobile device (mobile computer, tablet, smartphone, wearable device such as Google Glass), over a network such as the Internet. The computing device (or another device) may simultaneously record the user's facial expressions obtained using the camera of the computer or the mobile device, or another camera. The computing device may analyze the facial expressions of the user to estimate the user's valence and arousal, either substantially in real time or at a later time, and store the estimates. Based on the estimates of valence and arousal, new advertisement or incentive (whether web-based, mailing, or of another kind) may be displayed or otherwise delivered to the user.

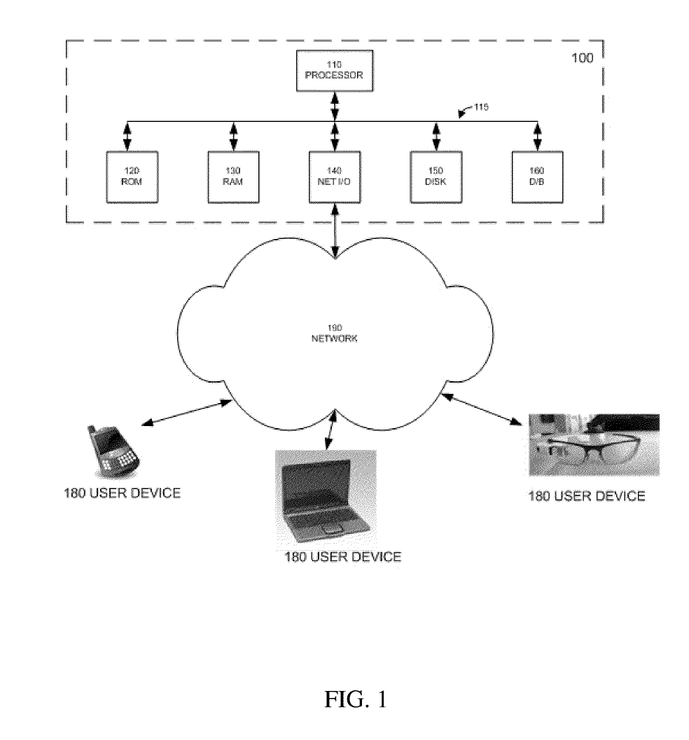

FIG. 1 is a simplified block diagram representation of a computer-based system 100, configured in accordance with selected aspects of the present description. The system 100 interacts through a communication network 190 with users at user devices 180, such as personal computers and mobile devices (e.g., PCs, tablets, smartphones, Google Glass and other wearable devices). The system 100 may be configured to perform steps of a method (such as the method 200 described in more detail below) for determining valence and arousal of a user in response to a stimulus (such as an advertisement), receiving extended facial expressions of the user, analyzing the extended facial expressions to evaluate the user's response to the advertisement, and selecting a new advertisement or offer based on the valence and arousal evoked in the user by the first advertisement.

FIG. 1 does not show many hardware and software modules of the system 100 and of the user devices 180, and omits various physical and logical connections. The system 100 may be implemented as a special purpose data processor, a general-purpose computer, a computer system, or a group of networked computers or computer systems configured to perform the steps of the methods described in this document. In some embodiments, the system 100 is built using one or more of cloud devices, smart mobile devices, wearable devices. In some embodiments, the system 100 is implemented as a plurality of computers interconnected by a network, such as the network 190, or another network.

As shown in FIG. 1, the system 100 includes a processor 110, read only memory (ROM) module 120, random access memory (RAM) module 130, network interface 140, a mass storage device 150, and a database 160. These components are coupled together by a bus 115. In the illustrated embodiment, the processor 110 may be a microprocessor, and the mass storage device 150 may be a magnetic disk drive. The mass storage device 150 and each of the memory modules 120 and 130 are connected to the processor 110 to allow the processor 110 to write data into and read data from these storage and memory devices. The network interface 140 couples the processor 110 to the network 190, for example, the Internet. The nature of the network 190 and of the devices that may be interposed between the system 100 and the network 190 determine the kind of network interface 140 used in the system 100. In some embodiments, for example, the network interface 140 is an Ethernet interface that connects the system 100 to a local area network, which, in turn, connects to the Internet. The network 190 may therefore be a combination of several networks.

The database 160 may be used for organizing and storing data that may be needed or desired in performing the method steps described in this document. The database 160 may be a physically separate system coupled to the processor 110. In alternative embodiments, the processor 110 and the mass storage device 150 may be configured to perform the functions of the database 160.

The processor 110 may read and execute program code instructions stored in the ROM module 120, the RAM module 130, and/or the storage device 150. Under control of the program code, the processor 110 may configure the system 100 to perform the steps of the methods described or mentioned in this document. In addition to the ROM/RAM modules 120/130 and the storage device 150, the program code instructions may be stored in other machine-readable storage media, such as additional hard drives, floppy diskettes, CD-ROMs, DVDs, Flash memories, and similar devices. The program code may also be transmitted over a transmission medium, for example, over electrical wiring or cabling, through optical fiber, wirelessly, or by any other form of physical transmission. The transmission can take place over a dedicated link between telecommunication devices, or through a wide area or a local area network, such as the Internet, an intranet, extranet, or any other kind of public or private network. The program code may also be downloaded into the system 100 through the network interface 140 or another network interface.

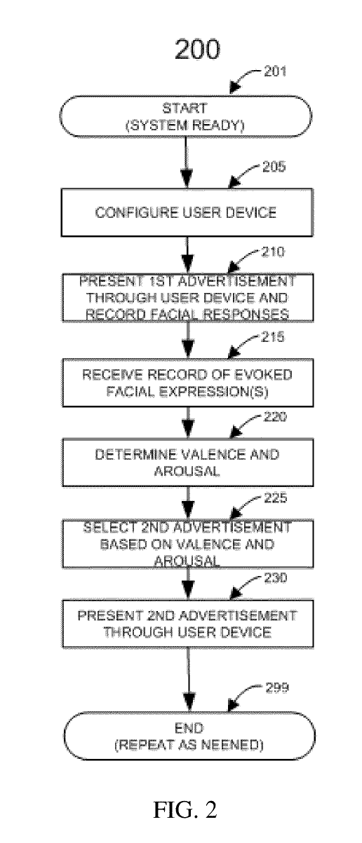

FIG. 2 illustrates selected steps of a process 200 for selecting and presenting advertisement based on valence and arousal evoked in a user. The method may be performed by the system 100 and/or the devices 180 shown in FIG. 1.

At flow point 201, the system 100 and a user device 180 are powered up and connected to the network 190.

In step 205, the system 100 communicates with the user device 180, and configures the user device 180 to play a first presentation (which may be an advertisement) to the user at the device 180, and to record simultaneously extended facial expressions of the person at the user device 180.

In step 210, the system 100 causes the user device 180 to present to the person at the device 180 the first presentation, and to record the user's extended facial expressions evoked by the first presentation. For example, the system 100 causes the user device 180 to display a first advertisement to the person through the device 180, and to video-record the user through the camera of the device 180.

In step 215, the system 100 obtains the recording of the person's extended facial expressions obtained by the user device in the step 210.

In step 220, the system 100 uses a machine learning system trained to estimate affective valence and arousal (as described above), to analyze the extended facial expressions of the person evoked by the first presentation and to determine or estimate the valence and/or arousal of the person resulting from the first presentation.

In step 225, the system 100 selects a second presentation (which may be a second advertisement/offer) for the person, based in whole or in part on the valence and arousal evoked by the first presentation, as determined or estimated in the step 220. If, for example, the person's valence was negative, the second presentation may be selected from a different category than the first presentation. Similarly, if the valence was positive with strong arousal, the second presentation may be selected from the same category as the first one, or from an adjacent category. In embodiments, the second presentation is selected from a plurality of available second presentations (such as a plurality of advertisements that may contain still images, videos, smells). A table or a function maps the valence and arousal values evoked by the first presentation to the different available second presentations. The table or function may be more complex, mapping different combinations of the valence and arousal in conjunction with other data items regarding the person, to the different available second presentations. The data items regarding the person may include demographic data (such as age, income, wealth, ethnicity, geographic location, profession) and data items derived from other sources such as online activity of the person and purchasing history. The mapping function may be developed using machine learning methods such as reinforcement learning and optimal control methods.

In step 230, the system 100 causes the user device 180 to play to the person the second presentation.

At flow point 299, the process 299 may terminate, to be repeated as needed for the same user and/or other users, with the same stimulus or other stimuli.

The presentations/advertisements may be or include images (still pictures, videos), sounds (e.g., voice, music), smells (e.g., fragrances, perfumes).

The process 200 may be modified to be performed by a stand-alone device, such as a marketing kiosk. In this case, the operation of the system 100 and the user device 180 are combined in a single computing device.

The system and process features described throughout this document may be present individually, or in any combination or permutation, except where presence or absence of specific feature(s)/element(s)/limitation(s) is inherently required, explicitly indicated, or otherwise made clear from the context.

Although the process steps and decisions (if decision blocks are present) may be described serially in this document, certain steps and/or decisions may be performed by separate elements in conjunction or in parallel, asynchronously or synchronously, in a pipelined manner, or otherwise. There is no particular requirement that the steps and decisions be performed in the same order in which this description lists them or the Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts. It should be noted, however, that specific embodiments/variants/examples use the particular order(s) in which the steps and decisions (if applicable) are shown and/or described.

The instructions (machine executable code) corresponding to the method steps of the embodiments, variants, and examples disclosed in this document may be embodied directly in hardware, in software, in firmware, or in combinations thereof. A software module may be stored in volatile memory, flash memory, Read Only Memory (ROM), Electrically Programmable ROM (EPROM), Electrically Erasable Programmable ROM (EEPROM), hard disk, a CD-ROM, a DVD-ROM, or other form of non-transitory storage medium known in the art, whether volatile or non-volatile. Exemplary storage medium or media may be coupled to one or more processors so that the one or more processors can read information from, and write information to, the storage medium or media. In an alternative, the storage medium or media may be integral to one or more processors.

This document describes the inventive apparatus, methods, and articles of manufacture for determining affective valence and arousal based on facial expressions, and using the valence and arousal. This was done for illustration purposes only. The specific embodiments or their features do not necessarily limit the general principles described in this document. The specific features described herein may be used in some embodiments, but not in others, without departure from the spirit and scope of the invention as set forth herein. Various physical arrangements of components and various step sequences also fall within the intended scope of the invention. Many additional modifications are intended in the foregoing disclosure, and it will be appreciated by those of ordinary skill in the pertinent art that in some instances some features will be employed in the absence of a corresponding use of other features. The illustrative examples therefore do not necessarily define the metes and bounds of the invention and the legal protection afforded the invention, which function is carried out by the claims and their equivalents.

What is claimed is:

1. A computer-implemented method comprising steps of:
obtaining a first image containing an extended facial expression of a person;
processing the first image containing the extended facial expression of the person with a machine learning classifier to obtain a first estimate of valence and arousal of the person in the first image, wherein the classifier is trained using training data created by (1) recording extended facial expression appearances of individuals, and (2) obtaining ground truths of valence and arousal of the individuals, the ground truths corresponding to the extended facial expression appearances.

2. A computer-implemented method as in claim 1, wherein the first image is of the person engaged in spontaneous behavior.

3. A computer-implemented method as in claim 1, further comprising:
presenting a first eliciting stimulus to the person, the extended facial expression of the person in the first image being in response to the first eliciting stimulus.

4. A computer-implemented method as in claim 3, further comprising:
selecting a second eliciting stimulus for the person based at least in part on the first estimate of valence and arousal of the person; and
presenting to the person the second eliciting stimulus.

5. A computer-implemented method as in claim 3, wherein the first eliciting stimulus comprises a first advertisement, the method further comprising:
presenting to the person a second advertisement;
obtaining a second image containing an extended facial expression of the person responding to the second advertising;
processing the second image containing the extended facial expression of the person responding to the second advertising with the machine learning classifier to obtain a second estimate of valence and arousal of the person;
comparing the first estimate and the second estimate; and
indicating a result of the step of comparing, the step of indicating comprising at least one of storing the result of the step of comparing, transmitting the result of the step of comparing, and displaying the result of the step of comparing.

6. A computer-implemented method as in claim 5, wherein the first image is obtained at the time when the person observes a first part of a video, and the second image is obtained when the person observes a second part of the video, the method further comprising:
displaying timeline of the video with the first estimate placed nearer time of the first part of the video than time of the second part of the video, and the second estimate placed nearer time of the second part of the video than time of the first part of the video.

7. A computer-implemented method as in claim 5, further comprising repeating the method for another person.

8. A computer-implemented method as in claim 4, wherein the step of selecting comprises identifying the second eliciting stimulus from a function mapping a plurality of possible estimates of valence and arousal evoked by the first eliciting stimulus to a plurality of selections available for the second eliciting stimulus, wherein the function is developed using one or more machine learning methods.

9. A computer-implemented method as in claim 4, wherein the step of selecting comprises identifying the second eliciting stimulus from a function mapping a plurality of possible estimates of valence and arousal evoked by the first eliciting stimulus in conjunction with demographic data, to a plurality of selections available for the second eliciting stimulus, wherein the function is developed using a method selected from the group consisting of reinforcement learning and optimal control methods.

10. A computer-implemented method as in claim 4, further comprising:
step for selecting a second eliciting stimulus for the person based at least in part on the first estimate of valence and arousal of the person responding to the first eliciting stimulus; and
presenting to the person the second eliciting stimulus.

11. A computer-implemented method comprising:
training a machine learning classifier using training data created by (1) recording extended facial expression appearances of individuals when the individuals, and (3) obtaining ground truths of valence and arousal of the individuals, the ground truths corresponding to the extended facial expression appearances of the individuals, thereby obtaining a machine learning classifier trained to estimate valence and arousal.

12. A computer-implemented method as in claim 11, further comprising:
processing an image of a person with the classifier to generate an estimate of valence and arousal of the person.

13. A computing device comprising:
at least one processor;
machine-readable storage, the machine-readable storage being coupled to the at least one processor, the machine-readable storage storing instructions executable by the at least one processor; and
means for allowing the at least one processor to obtain images comprising extended facial expressions of a person;
wherein:
the instructions, when executed by the at least one processor, configure the at least one processor to implement a machine learning classifier trained to estimate valence and arousal, wherein the classifier is trained with training data created by (1) recording extended facial expression appearances of individuals, and (2) obtaining ground truths of valence and arousal, the ground truths corresponding to the extended facial expression appearances of the individuals; and
the instructions, when executed by the at least one processor, further configure the at least one processor to analyze a first image comprising an extended facial expression of the person, using the classifier, thereby obtaining an estimate of valence and arousal of the person.

14. A computing device as in claim 13, further comprising:
means for presenting a first eliciting stimulus to the person.

15. A computing device as in claim 14, wherein:
the means for allowing the at least one processor to obtain images comprises a camera of the computing device; and
the means for presenting comprises a display of the computing device.

16. A computing device as in claim 14, wherein:
the means for allowing the at least one processor to obtain images comprises a network interface coupling through a network the computing device to a user device; and
the means for presenting comprises the network interface.

17. A computing device as in claim 13, wherein the instructions, when executed by the at least one processor, further configure the at least one processor to select a second eliciting stimulus based at least in part on the estimate of valence and arousal of the person responding to the first eliciting stimulus.

18. A computing device as in claim 17, further comprising:
means for presenting the first eliciting stimulus and the second eliciting stimulus to the person.

19. A computing device as in claim 18, wherein:
the means for allowing the at least one processor to obtain images comprises a network interface coupling the computing device through a network to a user device;
the means for presenting comprises the network interface;
wherein:
the computing device is configured to present the first eliciting stimulus and the second eliciting stimulus by sending signals to the user device through the network interface; and
the computing device is configured to obtain the images by receiving signals from the user device through the network interface.

20. A computer-implemented method comprising steps of:
obtaining a plurality of images containing extended facial expressions of a plurality of persons at a plurality of times;
processing the plurality of images with a machine learning classifier to obtain a plurality of estimates of valence and arousal of the plurality of persons, wherein the classifier is trained using training data created by (1) recording extended facial expression appearances of individuals, and (2) obtaining ground truths of valence and arousal of the individuals, the ground truths corresponding to the extended facial expression appearances;
computing statistics of valence and arousal of the plurality of persons over time; and
at least one of storing, displaying, and transmitting the statistics.
